(19) United States
(12) Patent Application Publication
(10) Pub. No.: US 2022/0019689 A1
(43) Pub. Date: Jan. 20, 2022

(54) Privacy Preserving Server-Side Personalized Content Selection

(71) Applicant: Apple Inc., Cupertino, CA (US)

(72) Inventors: Chi Wai Lau, Santa Clara, CA (US); Dominic J. Hughes, Menlo Park, CA (US); Sudeep Agarwal, Cupertino, CA (US); Martin J. Murrett, Los Gatos, CA (US)

(73) Assignee: Apple Inc., Cupertino, CA (US)

(21) Appl. No.: 17/152,125

(22) Filed: Jan. 19, 2021

Related U.S. Application Data
(60) Provisional application No. 63/051,603, filed on Jul. 14, 2020.

(51) Int. Cl. G06F 21/62

(52) U.S. Cl. CPC G06F 21/6245

(57) ABSTRACT

In some implementations, a computing system can be configured to perform personalized content item selection in a privacy preserving manner. In some implementations, user privacy can be protected by performing the personalized selection of content items on the user's device. For example, the computing system can include a client device configured to select content items from a collection of candidate content items received from a server device based on a user profile generated and stored on the client device. In some implementations, user privacy can be protected when performing the personalized selection of content items by sending an anonymous, or approximate, user profile (e.g., class profile) to the server device. For example, the computing system can include a server device configured to select content items from a collection of content items based on a class profile representing a group of similar user profiles received from the client device.

### RELATED APPLICATIONS

This application claims the benefit of the filing date of U.S. Provisional Patent Application No. 63/051,603 filed on Jul. 14, 2020, which is hereby incorporated by reference.

### TECHNICAL FIELD

The disclosure generally relates to content selection techniques. In particular this disclosure relates to selecting content based on user personalization data in a privacy preserving manner.

### BACKGROUND

Computing devices are often used to view various types of content. Content delivery services are often configured to provide personalized content selections to specific users. Some content delivery services (e.g., content servers) will collect sensitive personal user information (e.g., preferences, interests, content viewing history, user identification information, etc.) and select content items to present to the user (e.g., send to the user's computing device) based on the personal user information. However, collecting and storing this sensitive, personal information at the content delivery service risks exposing this personal information to malicious third parties. Some content delivery services mitigate the risk of exposing this sensitive personal information by performing personalized content selection on the user device. For example, the user device may not share the user's personal information with the content delivery service. Instead, the content delivery service can send candidate content items to the user device, and the user device can select content items to present to the user from the candidate items based on the user's personal information stored on the user device. While this may provide a personalized content selection mechanism that better protects the user's privacy, it prevents the content delivery service from being able to send personalized content selections to the user's computing device.

### SUMMARY

In some implementations, a computing system can be configured to perform personalized content item selection in a privacy preserving manner. In some implementations, user privacy can be protected by performing the personalized selection of content items on the user's device. For example, the computing system can include a client device configured to select content items from a collection of candidate content items received from a server device based on a user profile generated and stored on the client device. In some implementations, user privacy can be protected when performing the personalized selection of content items by sending an anonymous, or approximate, user profile (e.g., class profile) to the server device. For example, the computing system can include a server device configured to select content items from a collection of content items based on a class profile representing a group of similar user profiles received from the client device.

Particular implementations provide at least the following advantages. A user's private, personal information related to the user's content viewing behavior can be protected by retaining user specific information on the user's device and not distributing the user's private information in a way that can be traced back to a specific user or traced back to specific user behavior. A common machine learning model for estimating the likelihood that a user will read or view a content item can be distributed among client devices and server devices. The process for predicting whether a user will read or not read a content item can be made more efficient by reducing, or combining, the number of dimensions (e.g., user profile attributes, content item profile attributes, etc.) that are evaluated when making content item viewing predictions. The computing system can be made more efficient and the user experience improved by only selecting and/or presenting content items that the user is likely to read or consume. The computing system can change the machine learning model (e.g., neural net) configuration on the server device and the user device simultaneously (or at about the same time) through configuration sent to the user device.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for privacy preserving server-side personalized content selection.

FIG. 2 is a block diagram of an example system for performing personalized content selection on a user device.

FIG. 3 is a block diagram of an example machine learning model for generating content item scores representing the likelihood that a user will read a content item.

FIG. 4 is a block diagram of an example system for performing personalized content selection on a server device.

FIG. 5 is a block diagram of an example machine learning model for generating content item scores representing the likelihood that a user will read a content item.

FIG. 6 is a flow diagram of an example process for generating reduced content item profiles for content items.

FIG. 7 is a flow diagram of an example process for determining reduced user profile attributes and generating user class profiles.

FIG. 8 is a flow diagram of an example process for training a machine learning model to generate content item scores based on past user behavior.

FIG. 9 is a flow diagram of an example process for performing personalized selection of content items on a client device.

FIG. 10 is a flow diagram of an example process for updating a detailed user profile based on user content viewing activity.

FIG. 11 is a flow diagram of an example process for providing anonymized personalization information for server-side personalized content selection.

FIG. 12 is a flow diagram of an example process for privacy preserving personalized selection of content items at a server device.

FIG. 13 is a block diagram of an example computing device that can implement the features and processes of FIGS. 1-12.

Like reference symbols in the various drawings indicate like elements.

### DETAILED DESCRIPTION

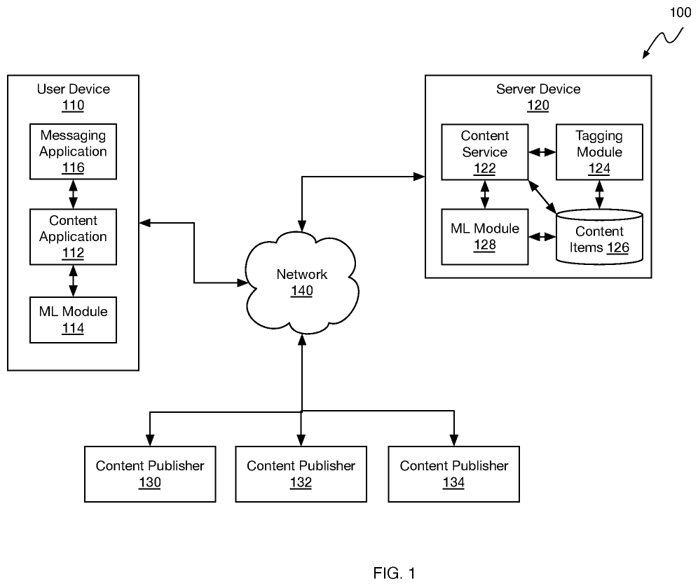

FIG. 1 is a block diagram of an example system 100 for privacy preserving server-side personalized content selection. In some implementations, system 100 can be configured to perform both server-side and client-side personalized content selection while preserving the privacy and/or anonymity of the user of a user device. For example, system 100 can be configured with a machine learning model that can predict the likelihood that a particular user will view (e.g., select, read, etc.) a particular content item based on a user profile that represents the particular user's content viewing preferences and a content item profile that represents what the content item is about (e.g., topics, or combination of topics, to which the content item is related). The machine learning model can be deployed on both the user device (e.g., client-side) and the server device (e.g., content service) so that either device can use the model to perform personalized selection of content items to present to the user of the user device.

When personalized content selection is to be performed on the user device, the content service can provide candidate content items and the corresponding content item profiles to the user device. The user device then can provide the content item profiles and the on-device user profile as input to the machine learning (ML) model so that the ML model can generate scores for the content items that represent the likelihood that the user will view the candidate content items. The user device can select a number of the highest scored content items to present to the user. For example, this on-device personalized content selection approach may be used when an application on the user device is configured to select content items from a collection of candidate content items for presentation to a user of the user device according to the user's personal preferences (e.g., explicit preferences, viewing history, etc.).

When personalized content selection is to be performed on the server device, the user device can generate an anonymized version of the user profile (e.g., a class profile having k-anonymity) and send the anonymized version of the user profile to the server device. The server device can then provide the anonymized user profile and content item profiles for candidate content items to the ML model so that the ML model can generate scores for the content items that represent the likelihood that the user will view the candidate content items. The server device can select a number of the highest scored content items to send to the user device for presentation to the user. For example, this server-side personalized content selection approach may be used when a content service is configured to push a personalized selection of content items to the user device (e.g., through email, push notifications, or other communication mechanism) to encourage the user of the user device to increase the user's engagement with the content service. An example implementation of the personalized content selection approaches described above is described in detail in the following paragraphs.

In some implementations, system 100 can include user device 110. For example, user device 110 can be a personal computing device (e.g., a desktop computer, laptop computer, tablet computer, smartphone, etc.), wearable device (e.g., a smartwatch, smart glasses, etc.), a streaming device (e.g., a smart speaker, a set-top-box, etc.), a vehicle infotainment system, or any other computing device.

In some implementations, user device 110 can include content application 112. For example, content application 112 can be a software application configured to present content to the user of user device 110 through the various output devices (e.g., display, speakers, headphones, etc.) connected to user device 110. Content application 112 can be a software client of a content providing service (e.g., content service 122). Content application 112 can provide user interfaces that allow the user of user device 110 to search, browse, view, play, or otherwise interact with content provided by the content providing service. For example, the content can be video media content, such as television shows, movies, amateur videos, etc. The content can be audio media content, such as talk shows, podcasts, lectures, etc. The content can be textual content, such as news articles, opinion pieces, scientific white papers, etc. However, to simplify the descriptions that follow, the content presented by content application 112 and provided by the content service 122 will be described as news articles provided by various content publishers (e.g., content publishers 130, 132, 134), aggregated and served by content service 122, and presented by application 112 or other application (e.g., messaging application 116) on user device 110.

In some implementations, content application 112 can perform personalized selection of content items for presentation to the user of user device 110. For example, content application 112 can receive candidate content items from content service 122. Content application 112 can provide a user profile, that represents the content viewing (e.g., reading, consumption, etc.) habits of the user, and content item profiles for the candidate content items to a machine learning model (e.g., machine learning module 114). The machine learning model can generate a score (e.g., a numerical value, a probability, etc.) for each candidate content item representing the likelihood that the user will view the candidate content item. Content application 112 can select the candidate content items having the highest scores to present to the user on a graphical user interface of content application 112 presented on a display of user device 110. By performing content item personalization on user device 110, system 100 can avoid sending the user's profile across the network (e.g., network 140) thereby minimizing the risk that the user's sensitive, personal information might be intercepted by malicious external actors.

In some implementations, user device 110 can include machine learning module 114. For example, machine learning (ML) module 114 can be configured with a machine learning model, and/or other configuration as may be described herein, for predicting and/or selecting content that the user is likely to read or view. For example, the machine learning module can be configured as a neural network that can predict based on a detailed user profile that represents the user's content preferences and a detailed content item profile that represents the content of a content item whether the user will read or view the corresponding content item.

In some implementations, ML module 114 and/or the ML model may perform a dimensionality reduction process (e.g., principle component analysis, factor analysis, multi-dimensional scaling, etc.) on the detailed user profile and/or the detailed content item profile to generate a reduced user profile (e.g., having fewer dimensions and/or attributes) and/or a reduced content item profile (e.g., having fewer dimensions and/or attributes). The reduced user profile and the reduced content item profile can be provided as input to the machine learning model and the machine learning model can output a value (e.g., a score, probability, etc.) that represents the likelihood that the user will read or view the corresponding content item. Since the dimensionality reduction process results in a reduced set of dimensions that represent the most important (e.g., most influential, most variant, most determinative, etc.) aspects of the user profile and/or the content item profile, the reduced profiles allow the machine learning model to make a prediction more efficiently by processing fewer inputs that have the greatest impact on the prediction.

In some implementations, user device 110 can include messaging application 116. For example, messaging application 116 can be an e-mail application, instant messaging application, social media application, or other type of application capable of sending and/or receiving electronic messages. However, for simplicity, messaging application 116 may be referred to herein as an e-mail application. In some implementations, messaging application 116 can receive electronic messages (e.g., email) from content service 122 that include personalized content selections. For example, content application 112 can send (e.g., periodically, upon invocation, in response to some event, in response to a request from content service 122, etc.) user personalization information to content service 122. The user personalization information can, for example, be anonymized such that the exact details of the user profile are not sent to content service 122 but, instead, an approximation of the user profile (e.g., a reduced user profile, a class profile, etc.) can be sent to content service 122. Content service 122 can then use the anonymized user personalization information to generate personalized content selections to send to the user in an electronic message (e.g., an email newsletter) received by messaging application 116. The user can select a content item included in the electronic message to cause content application 112 to present the selected content item for viewing by the user.

In some implementations, system 100 can include server device 120. For example, server device 120 can be a computing device configured to serve content to client devices (e.g., user device 110). While only one server device 120 is shown in FIG. 1, system 100 may include multiple server devices 120. Each server device can include one or more of the components, modules, and/or processes described with respect to server device 120. For example, system 100 can include multiple server devices where each server device includes all of the features of server device 120, as described herein. System 100 can include multiple server devices where the features of server device 120 are distributed across the multiple server devices such that one server device may perform a specific function, or functions, described with respect to server device 120 that is different than another server device.

In some implementations, server device 120 can include content service 122. For example, content service 122 can be a software server configured to serve content items (e.g., news articles) to client devices (e.g., user device 110) and/or client applications (e.g., content application 112, messaging application 116). Content service 122 can receive content items from various content publishers (e.g., content publishers 130, 132, 134, etc.), store the content items in content item database 126, and process the stored content items for distribution to various client devices.

In some implementations, server device 120 can include tagging module 124. For example, tagging module 124 can analyze the content of content items received by content service 122 (e.g., stored in content items database 126) and generate metadata tags describing the content of the content items. For example, news articles may be written that cover various diverse topics (e.g., sports, politics, weather, cooking, health, etc.). The topic can range from broad categories (e.g., politics, sports, health, etc.) to narrow subjects (e.g., specific political figures, specific sports stars, specific health issues, etc.). Tagging module 124 can determine topics to which the received news articles are related and store tags (e.g., labels) corresponding to the topics as metadata for each received news article. Tagging module 124 can generate scores (e.g., relevance scores, importance scores, etc.) representing how important a tag (e.g., topic) is to the news article. For example, a news article that describes a political issue that was raised at a sporting event by a specific athlete may include tags representing these topics (e.g., politics, sports, athlete's name, etc.) and corresponding scores indicating how important these tags are to the content of the article. These tags and corresponding scores can be subsequently used to select content items (e.g., news articles) to present to the user according to the user's personal preferences (e.g., user profile).

In some implementations, server device 120 can include machine learning module 128. For example, ML module 128 can be configured to determine the dimensions (e.g., reduced dimensions, aggregate attributes, dimension vectors, etc.) corresponding to the reduced user profile and/or reduced content item profile. The reduced dimensions can be determined using one of various dimension reduction processes, such as principle component analysis, factor analysis, multi-dimensional scaling, etc. However, for simplicity, this description will focus on principle component analysis as the process for dimensionality reduction of the user profile and/or content item profile. As principle component analysis may result in selection of dimensions (e.g., eigenvectors) that represent a combination of detailed user profile or detailed content item profile attributes, these reduced dimensions may be referred to as composite attributes or composite dimensions derived from the detailed user profile attributes and/or detailed content item profile attributes. For example, the eigenvector can be defined in terms of a ratio of multiple detailed profile attributes (e.g., 1 part sports, 3 parts politics, 6 parts entertainment, etc.). The definition of these composite dimensions (e.g., principle components) may be determined by performing principle component analysis on a large number of (e.g., anonymous) user profiles and/or content item profiles to determine the principle components of the user profiles and content item profiles. ML module 128 can store the definitions (e.g., eigenvectors) for the user profile principle components and content item principle components. Content service 122 can distribute the principle components definitions to client devices so that client devices can project user profile attribute values (e.g., topic interest scores) and/or content item attributes (e.g., tags, tag relevance scores, dimensions, etc.) onto the principle components to generate reduced user profiles and/or reduced content item profiles.

In some implementations, content service 122 or ML module 128 can project content item attribute values (e.g., tag relevance scores, dimensions, etc.) onto the principle components selected for reduced content item profiles to generate reduced content item profiles for tagged content items. The reduced content item profiles (e.g., low dimensional profiles representing the topics relevant to a content item) can be stored and/or delivered to client devices (e.g., user device 110) as metadata for corresponding candidate content items.

In some implementations, ML module 128 can generate a machine learning model that estimates a likelihood that a particular user will read a particular content item. For example, the machine learning model can be a neural network that takes a reduced user profile and a reduced content item profile as input, and generates a score representing the likelihood that a user associated with the reduced user profile will read or view the corresponding content item. ML module 128 can train the ML model based on user activity data received from a large number of user devices related to content consumption behavior of the users of those user devices. The user activity data can include a representation of the user profile for a user (e.g., a reduced user profile, an anonymized user profile, etc.) and an indication of content items read and not read by the user of the user device. ML module 128 can then train the neural network to accurately determine the likelihood that a user with a particular user profile will read or not read a particular content item.

After the ML model is trained, the ML model can be stored by ML module 128 and distributed to client devices (e.g., user device 110) by content service 122. The ML model can then be used by content service 122 and/or content application 112 to determine which content items a user will likely read and select these content items for presentation to the user so that the selection of content items presented to the user can be personalized to the user's content consumption habits, as described further below. For example, content service 122 on server device 120 can use the ML model to select content items to present in a newsletter sent to a specific user based on a user profile (e.g., anonymized class profile) received from the user device corresponding to that specific user. Content application 112 on user device 110 can use the ML model to select content items to present as suggested content items on a graphical user interface of content application 112.

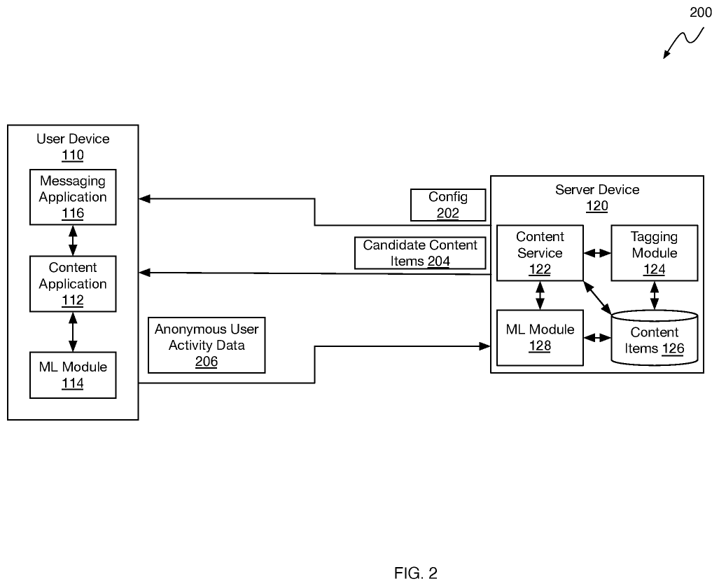

FIG. 2 is a block diagram of an example system 200 for performing personalized content selection on a user device. For example, system 200 can correspond to system 100 described above. In system 200, content application 112 can use a machine learning model (e.g., neural network) trained by and received from content service 122 to determine whether the user of user device 110 is likely to read or consume a candidate content item received from content service 122. Content application 112 can then select the candidate content items that the user is most likely to read and present the selected content items on a user interface of content application 112.

In some implementations, content service 122 can send configuration 202 to content application 112. For example, configuration 202 can include data defining the machine learning model (e.g., neural network) for estimating the likelihood that a user will read a candidate content item. For example, the definition for the machine learning module can include definitions for the nodes at various levels of the neural network, relationships between nodes, weights assigned to inputs, bias values, etc.

In some implementations, configuration 202 can include data defining the principle components (e.g., eigenvectors, attributes, etc.) selected for the reduced content item profile. For example, in some implementations, ML module 114 on user device 110 can generate a reduced content item profile for each received content item based on the detailed content item profile in the content item metadata that includes all of the tags and corresponding relevance scores associated with the tags. To generate the reduced content item profile on user device 110, user device 110 can receive the definition of the principle components (e.g., attributes, eigenvectors, etc.) for the reduced content item profile as determined by ML module 128 on server device 120. Thus, ML module 114 on user device 110 can project the tag relevance scores onto the principle components to generate the corresponding values for the reduced content item profile.

In some implementations, user device 110 may receive the reduced content item profile as part of the metadata for a corresponding candidate content item. Thus, ML module 114 may not generate the reduced content item profile on user device 110. Instead, ML module 114 may just provide the reduced content item profile received from server device 120 as input to the machine learning model, as described further below.

Configuration 202 can include data defining the principle components (e.g., eigenvectors, attributes, etc.) selected for the reduced user profile. For example, to allow ML module 114 on various user devices (e.g., user device 110) to generate reduced user profiles that are consistent with other reduced user profiles generated by other user devices, content service 122 can send the principle component definitions determined by ML module 128 on server device 120 to client devices (e.g., user device 110). For example, user device 110 may not be able to determine the principle components independently because user device 110 does not have access to user profile data from other user devices and/or other users that is required to determine the principle components for a common (e.g., common across multiple users and user devices) reduced user profile definition. Thus, as described below, since content service 122 can receive anonymized detailed user profile data from many different users and/or user devices, ML module 128 can determine the principle components by analyzing a large number of detailed user profiles. The principle component definitions (e.g., eigenvector definitions) can be distributed to user devices (e.g., user device 110) so that ML module 114 on user device 110 can project the attribute values (e.g., topic interest scores, topic disinterest scores, groupable topic scores, publisher scores, etc.) of the detailed user profile associated with the user of user device 110 onto the principle component vectors (e.g., eigenvectors, attributes, etc.) to generate the attribute values for the reduced user profile.

Configuration 202 can include data defining the class profiles (e.g., a k-anonymity profile) used for anonymizing the reduced user profile of a user. For example, as described above, ML module 128 can analyze a large number of anonymous detailed user profiles to determine the principle components of user profiles across many different users and/or user devices. ML module 128 can then project the detailed user profile data onto the principle component vectors (e.g., reduced user profile attributes) to determine the numerical values for the attributes (e.g., principle components) of the reduced user profile. ML module 128 can determine clusters of similar user profiles and generate a class profile based on the centroid of the determined clusters.

In some implementations, ML module 128 can generate a class profile that satisfies a k-anonymity requirement. For example, ‘k’ can be some number that when the class profile is generated, the class profile can be mapped to or represent any one of that number of people or profiles. Thus, if ‘k’ is 5000, then the generated class profile can represent the centroid values of a cluster of at least 5000 similar profiles. By using this k-5000 class profile, the user's profile can be anonymized amongst 5000 other users while still retaining a good approximation of a user's personalization information that can be used to personalize the selection of content items to a user's preferences while still protecting the user's privacy.

In some implementations, server device 120 can send candidate content items 204 to user device 110. For example, content service 122 can select candidate content items from content items database 126 to send to content application 112 on user device 110. Candidate content items 204 can be selected automatically. For example, content service 122 can select the most recent content items (e.g., within the last 12 hours, 24 hours, 2 days, etc.) as candidate content items. Content service 122 can select content items based on popularity or current trending topics. In some implementations, candidate content items 204 can include content items curated by administrators of content service 122. For example, a person (e.g., editor, administrator user, etc.) can review available content items and select content items for inclusion in candidate content items 204. After selection, candidate content items 204 can be sent by content service 122, along with corresponding content item metadata, to content application 112.

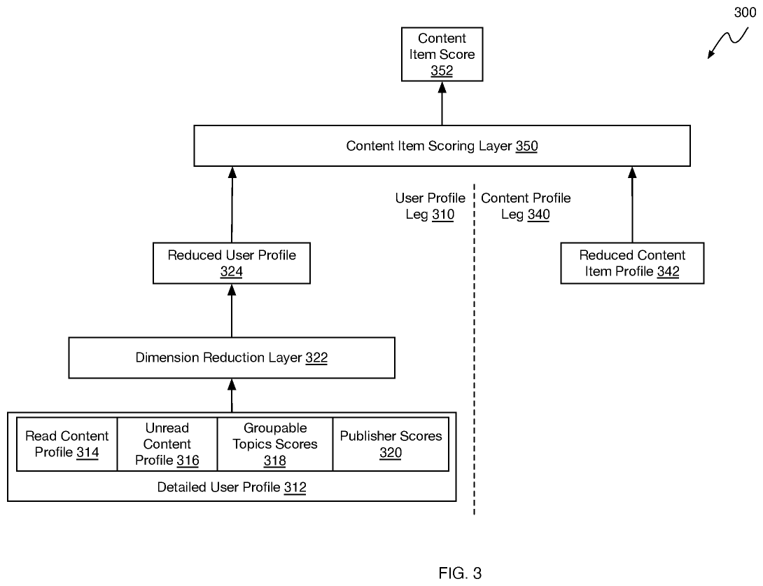

When candidate content items 204 are received by content application 112 on user device 110, content application 112 can select candidate content items for presentation to the user based on content item scores generated for each candidate content item by ML module 114. For example, ML module 114 can include a machine learning model (e.g., neural network) that has been trained by server device 120 to generate content item scores representing the likelihood that a user will read or consume a corresponding content item. The machine learning model can be configured based on configuration data included in configuration 202, as described above. The machine learning model can generate a content item score for a content item based on a user profile that represents the user's content item preferences and a content item profile for the content item being scored, as illustrated by FIG. 3.

FIG. 3 is a block diagram of an example machine learning model 300 for generating content item scores representing the likelihood that a user will read a content item. Machine learning model 300 can be implemented by ML module 114 on user device 110 based on the ML model configuration data received in configuration 202. For example, ML model 300 can be implemented as a neural network based on the neural network configuration data received in configuration 202.

In some implementations, ML model 300 can perform dimensionality reduction with respect to detailed user profiles and/or detailed content item profiles to generate reduced user profiles and/or reduced content item profiles. ML model 300 can then generate content item scores representing the likelihood that a content item will be read by the user based on the reduced user profile and the reduced content item profile.

Alternatively, dimensionality reduction with respect to detailed user profiles and/or detailed content item can be performed as a pre-processing step so that the reduced user profile and the reduced content item profile can be provided as input to machine learning model 300. For example, instead of performing dimensionality reduction with respect to detailed content item profiles on user device 110, ML model 300 can take the reduced content item profile generated by server device 120 and received as metadata for each candidate content item as input to ML model 300. Similarly, instead of performing dimensionality reduction with respect to detailed user profiles each time a content item is scored, ML model 300 can generate a reduced user profile and use the same reduced user profile to score multiple content items.

In some implementations, ML model 300 can include a user profile leg 310 and a content profile leg 340. For example, user profile leg 310 can perform some initial processing on user profiles before ML model 300 compares the user profile (e.g., reduced user profile) to the content item profile corresponding to a candidate content item. Similarly, content profile leg 340 can perform some initial processing on content item profiles before ML model 300 compares the content item profile (e.g., reduced content item profile) corresponding to a candidate content item to the user profile. By organizing ML model 300 (and ML model 500) in this way, ML model 300/500 can be distributed across client and server devices such that user privacy and/or anonymity can be preserved, as described below.

In some implementations, user profile leg 310 can perform dimensionality reduction on a detailed user profile. For example, ML model 300 can receive detailed user profile 312 (or reduced user profile 324) as input to user profile leg 310 of ML model 300. For example, if a reduced user profile 324 has already been generated for the current version of the detailed user profile 312, then ML model 300 can receive reduced user profile 324 as input. However, if the detailed user profile has been changed or updated since reduced user profile 324 was generated based on recent user activity, then ML model 300 can receive the detailed user profile 312 as input and regenerate reduced user profile 324 based on the updated detailed user profile 312.

In some implementations, detailed user profile 312 can include several components representing the content item preferences of the user. For example, the components of the user profile can include a read content profile 314, an unread content profile 316, groupable topics scores 318, and/or publisher scores 320.

In some implementations, detailed user profile 312 can include read content profile 314 that describes content items that the user has selected to read. For example, since content application 112 on user device 110 receives a detailed content item profile (e.g., topic tags, tag relevance scores, publisher identifiers, etc.) for each content item received from content service 122, content application 112 can generate read content profile 314 that represents content items that the user has previously (e.g., historically) read or consumed.

In some implementations, read content profile 314 can be generated by averaging the relevance scores for topic tags across content items read by the user associated with detailed user profile 312. For example, different content items read by the user may have different relevance scores for the “politics” topic tag. The user's interest in a topic can be estimated by the relevance of the topic to the content items the user reads or consumes. The interest score for the “politics” topic tag in the read content profile can be calculated by averaging the relevance scores for the “politics” tag from, or across, all of the read content items. Thus, averaging the relevance scores associated with a particular topic from multiple read content items can provide an estimation of the user's interest in the particular topic. This averaging can be performed across all topic tags to generate a broad representation of the user's interests in various topics based on the content the user has chosen to consume. Thus, read content profile 314 can include an array, vector, or mapping of interest scores for each topic tag that represents the user's level of interest in each topic.

In some implementations, detailed user profile 312 can include unread content profile 316 that describes content items that have been presented to the user but that the user has not read. For example, since content application 112 on user device 110 receives a detailed content item profile (e.g., topic tags, tag relevance scores, publisher identifiers, etc.) for each content item received from content service 122, content application 112 can generate unread content profile 316 that represents content items that the user has previously (e.g., historically) chosen to not read or consumed.

In some implementations, unread content profile 316 can be generated by averaging the relevance scores for topic tags across content items not read by the user associated with detailed user profile 312. For example, different content items not read by the user may have different relevance scores for the “sports” topic tag. The user's disinterest in a topic can be estimated by the relevance of the topic to the content items the user choses to not read or consume. The disinterest score for the “sports” topic tag in unread content profile 316 can be calculated by averaging the relevance scores for the “sports” tag from, or across, all of the unread content items. Thus, averaging the relevance scores associated with a particular topic from multiple unread content items can provide an estimation of the user's disinterest in the particular topic. This averaging can be performed across all topic tags to generate a broad representation of the user's disinterest in various topics based on the content the user has chosen to not consume. Thus, unread content profile 316 can include an array, vector, or mapping of interest scores for each topic tag that represents the user's level of disinterest in each topic.

In some implementations, detailed user profile 312 can include groupable topics scores 318. For example, groupable topics can be topics (e.g., tags) that content items are grouped under when presented on a graphical user interface of content application 112. For example, groupable topics can correspond to broad, high-level topics such as politics, sports, entertainment, technology, etc. Groupable topics scores 318 can represent the likelihood (e.g., probability) that a user will read or consume a content item related to the corresponding groupable topic. Groupable topics scores 318 can include multiple scores related, or mapped, to corresponding, respective groupable topics. The scores can be generated based on explicit user preferences, user content consumption behavior, or a combination thereof.

In some implementations, detailed user profile 312 can include publisher scores. For example, publishers can correspond to content generators, content originators, news outlets, newspapers, magazine publishers, and/or any other entity that creates content for public distribution. Publisher scores 320 can represent the likelihood (e.g., probability) that a user will read or consume a content item provided by a corresponding publisher. Publisher scores 320 can include multiple scores related, or mapped, to corresponding, respective publishers. The scores can be generated based on explicit user preferences, user content consumption behavior, or a combination thereof.

In some implementations, ML model 300 can include dimension reduction layer 322. For example, given the detailed nature of detailed user profile 312, detailed user profile 312 can have hundreds or thousands of dimensions corresponding to the tags, topics, publishers, etc., and corresponding scores. Processing a high dimension detailed user profile 312 can be inefficient and produce undesired results (e.g., due to the presence of noise in the large data set). Thus, model 300 can process detailed user profile 312 through a dimension reduction layer 322 to reduce the number of dimensions in the detailed user profile to a manageable level. Dimension reduction layer 322 can be configured to perform a dimensionality reduction method, such as Principle Component Analysis, Factor Analysis, Linear Discriminant Analysis, Multi-dimensional Scaling, or other linear or non-linear dimensionality reduction method. For simplicity, this disclosure will discuss dimensionality reduction with reference to Principle Component Analysis (PCA). Since user device 110 only has access to a single user profile, the identification of principle components can be performed by ML module 128 on server device 120 by performing PCA on a large number of anonymous detailed user profiles. Content application 112 can receive the definitions for the selected principle components (e.g., eigenvectors) for generating a reduced user profile. Dimension reduction layer 322 can project the dimensions or attributes of the detailed user profile 312 onto the defined principle components to generate values for reduced user profile 324. Since the number (e.g., 8, 9, 10, etc.) of selected principle components is fewer than the number of attributes of the detailed user profile 312, the number of dimensions represented in reduced user profile 324 will be fewer than the number of dimensions in the detailed user profile 312. For example, while the detailed user profile 312 may have thousands of dimensions, the reduced user profile 324 may have only 8 or 9. After generating the reduced user profile 324, user profile leg 310 can provide reduced user profile 324 as input to content item scoring layer 350 of ML model 300.

In some implementations, content profile leg 340 of ML model 300 can be configured to perform dimensionality reduction on a detailed content item profile. For example, ML module 114 can receive the definitions for the principle components (e.g., eigenvectors, profile attributes, etc.) for reduced content item profiles in configuration 202 received from server device 120. ML module 114 can project the attribute values (e.g., tag scores) of the attributes (e.g., topic tags) of the detailed content item profile (e.g., metadata) of a candidate content item onto the principle components selected as attributes for the reduced content item profile. Thus, ML module 114 can reduce a detailed content item profile having hundreds or thousands of attribute values (e.g., dimensions) down to a reduced content item profile having some significantly smaller number (e.g., 9, 10, 21, etc.) of attributes. However, since content service 122 generates and sends reduced content item profiles in the metadata for a candidate content item, content profile leg 34 may simply obtain the reduced content item profile for a content item being scored and provide the reduced content item profile as input to content item scoring layer 350.

In some implementations, ML model 300 can include content item scoring layer 350. For example, content item scoring layer 350 can be a neural network, or layer of a neural network, configured to receive reduced user profile 324 and reduced content item profile 342 as input and provide content item score 352 as output. Content item scoring layer 350 can be trained by ML module 128 on server device 120 using anonymous user activity data (e.g., anonymous user activity data 206) received from a large number of user devices. ML module 128 can be trained to output content item score for a particular content item corresponding to reduced content item profile 342 that represents the likelihood that a user corresponding to reduced user profile 324 will read or consume the particular content item.

Referring back to FIG. 2, after generating content item scores for each of the candidate content items, content application 112 can select a number of candidate content items having the highest scores for presentation on a graphical user interface of content application 112. Content application 112 can present the graphical user interface, including information identifying the selected content items, on a display of user device 11. As the user of user device 110 interacts with content application 112, the user may select or not select to view various content items identified by the graphical user interfaces of content application 112. As the user selects, or ignores, various content items, content application 112 can update the user's detailed profile (e.g., read content profile 312, unread content profile 316, groupable topic scores 318, publisher scores 320, etc.) to reflect this content consumption activity. In some implementations, content application 112 may store in the detailed user profile information identifying the content items that were selected and/or not selected by the user.

In some implementations, content application 112 can send anonymous user activity data 206 to content service 122. For example, anonymous user activity data can include the detailed user profile for the user and/or information identifying the content items that were selected and/or not selected by the user. Content application 112 can send the anonymous user activity data without including information that identifies the user (e.g., user account, user name, user location, email address, etc.) and/or the user's device (e.g., device identifier, MAC address, etc.) so that the user activity data cannot be traced back to a specific user or device. As described above and below, anonymous user activity data 206, along with anonymous user activity data received from a large number of other users and user devices, can be used by content service 122 and/or ML module 128 on server device 120 to identify principle components for the reduced user profile and train the ML model to calculate content item scores that accurately represent the likelihood that a user having a particular user profile will read or consume a particular content item.

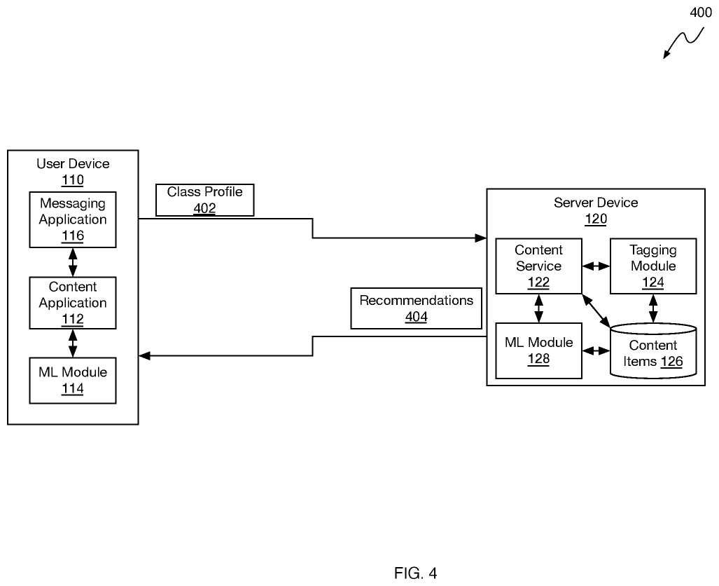

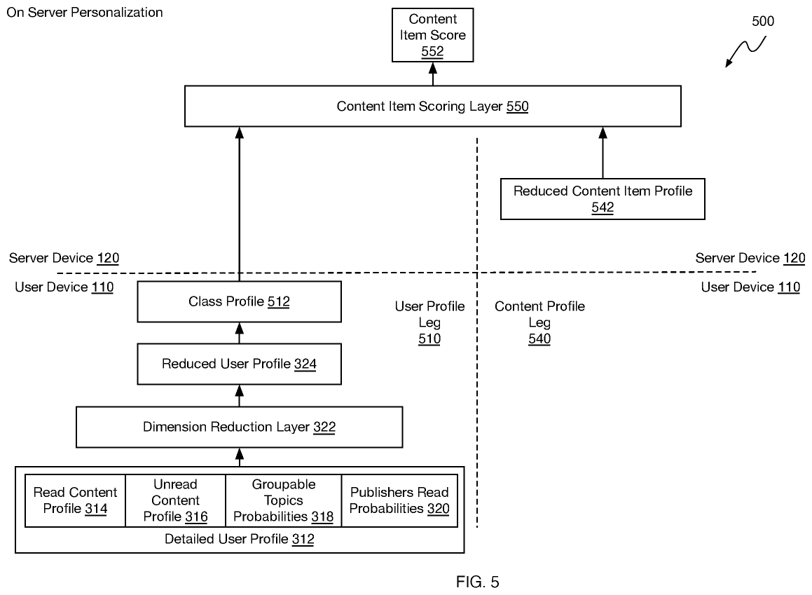

FIG. 4 is a block diagram of an example system 400 for performing personalized content selection on a server device. For example, system 400 can correspond to system 100 and/or system 200 described above. However, system 400 can perform personalized content selection on server device 120 in a privacy preserving manner using a k-anonymity approach that replaces a reduced user profile specific to a particular user with a class profile that corresponds to, or will be used by, some minimum number (e.g., k=5000, k=6000, etc.) of users. By using a class profile that represents, for example, 5000 other users as the user profile for performing personalized selection of content items on the server, system 400 provides a level of anonymity to the user and prevents specific user profile data from being obtained and used by malicious external actors. In some implementations, system 400 can be implemented by splitting the execution of ML model 300 between user device 110 and server device 120, as illustrated by FIG. 5.

FIG. 5 is a block diagram of an example machine learning model 500 for generating content item scores representing the likelihood that a user will read a content item. For example, ML model 500 can correspond to ML model 300. However, the user profile leg 510 of ML model 500 is performed on user device 110 to protect user privacy, while the content profile leg 540 and content item scoring layer 550 is performed on server device 120 to allow server device 120 to perform personalized content item selection. For example, user privacy can be protected by sending the anonymous class profile to the server device 120 instead of sending the detailed user profile and/or the reduced user profile that may include sensitive, private user information. Moreover, since the class profile is a specific instance of a reduced user profile that has attributes (e.g., dimensions) representing a combination of detailed user profile attributes, the class profile attributes add a layer of privacy protection since the definitions of the attributes will be unknown to an external malicious actor who may attempt to obtain the user's personal information. For example, the reduced user profile attributes of the class profile could represent multiple different detailed user profile attribute features in various proportions which can make the meaning of the corresponding attribute value more difficult to comprehend by an external actor.

In some implementations, ML model 500 can perform user profile leg 510 on user device 110. As described above, ML module 114 on user device 110 can obtain detailed user profile 312 and provide detailed user profile 312 to dimension reduction layer 322. For example, content application 112 can receive the definitions for the selected principle components (e.g., eigenvectors) for generating a reduced user profile. Dimension reduction layer 322 can project the dimensions, or attributes, of the detailed user profile 312 onto the defined principle components to generate values for reduced user profile 324. Since the number (e.g., 8, 9, 10, etc.) of selected principle components is fewer than the number of attributes of the detailed user profile 312, the number of dimensions represented in reduced user profile 324 will be fewer than the number of dimensions in the detailed user profile 312. For example, while the detailed user profile 312 may have thousands of dimensions, the reduced user profile 324 may have only 8 or 9.

After generating reduced user profile 324, user profile leg 510 can select a class profile 512 that most closely represents the principle component values in reduced user profile 324. As described above, user device 110 can receive class profiles (e.g., k-anonymity profiles, user class profiles, etc.) representing the content reading or viewing characteristics of various groups, or classes, of users. For example, different users may have similar interests and/or content consumption preferences or habits. User with similar interests will have similar, although not identical, user profiles and, therefore, similar reduced user profiles. These reduced user profiles can be clustered based on similarity of interests and many different clusters may be identified by server device 120. Server device 120 can generate class profiles for each cluster that correspond to centroid values of each cluster. The class profiles can be generated such that each class profile represents at least some minimum number of users (e.g., k-anonymity method). The class profiles can have the same attributes (e.g., principle components, eigenvectors, etc.) as the reduced user profiles but can have attribute values representing the centroid of the reduced user profile clusters. Server device 120 can send all of the determined or generated class profiles to user device 110 in configuration 202, as described above. ML model 500 can compare the reduced user profile 324 generated for the user of user device 110 to each of the received class profiles and select a particular class profile (e.g., class profile 512) that most closely resembles reduced user profile 324. For example, ML model 500 (e.g., user device 110) can compute the similarity between the reduced user profile and a particular class profile by calculating the distance (e.g., cosign distance, Euclidean distance, etc.) between the attributes values in the reduced user profile and attribute values for a class profile. The class profile that has the smallest distance (e.g., greatest similarity) can be selected to represent the reduced user profile.

Referring back to FIG. 4, after ML model 500 selects class profile 512, application 112 can send class profile 512 in class profile message 402 to content service 122 on server device 120. For example, class profile message 402 can include a user identifier (e.g., email address, account identifier, etc.) corresponding to the user of user device 110 and the selected class profile 512. Since class profile 512 is anonymized amongst a large number of users, the user's private information may still be protected despite the class profile being sent with user identification information.

After receiving class profile message 402, content service 122 can provide class profile 512 to ML module 128 so that ML module 128 can perform the server-side portion of ML model 500. For example, ML module 128 can obtain candidate content items to be evaluated by ML model 500. The candidate content items can be automatically or manually selected from content items database 126. For example, the candidate content items can be automatically selected based on various criteria, such as how much time has passed since the content item was published, the popularity of a content item, or other selection criteria. The candidate content items can be selected through a manual curation process performed by editorial staff or other administrators of content service 122. Content service 122 can send each of the candidate content items and the class profile 512 associated with the user of user device 110 to ML module 128 so that ML module 128 can generate a content item score for each candidate content item representing the likelihood that the user of user device 110 will read the corresponding candidate content item.

Referring back to FIG. 5, ML module 128 on server device 120 can be configured to perform the content profile leg 540 and content item scoring portions of ML model 500. When ML module 128 received candidate content items from content service 122, ML module 128 can iteratively process each candidate content item through ML model 500. For example, since server device 120 generates a reduced content item profile (e.g., reduced content item profile 542) for each content item after each content item is tagged, each candidate content item may already have metadata that includes a reduced content item profile 542 for the corresponding candidate content item.

When scoring a particular candidate content item, ML module 128 can provide the reduced content item profile 542 for the particular candidate content item as input to content item scoring layer 550. For example, content item scoring layer 550 may correspond to content item scoring layer 350 of FIG. 4. ML module 128 can provide class profile 512 received from user device 110 as input to content item scoring layer 550 as well. Thus, content item scoring layer 550 (e.g., a neural network) can generate a content item score 552 for a candidate content item based on the reduced content item profile 542 for a candidate content item and the class profile 512 approximating the interests or preferences of the user of user device 110.

Referring back to FIG. 4, after receiving the scores for the candidate content items, content service 122 can select a number of highest scored candidate content items and send the selected content items to user device 110. For example, content service 122 can send the selected content items in content items recommendations message 404 (e.g., a newsletter, recommendations list, e-mail, etc.) to messaging application 116.

### Example Processes

To enable the reader to obtain a clear understanding of the technological concepts described herein, the processes described below describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the descriptions of the processes may omit or briefly summarize some of the details of the technologies disclosed herein for clarity, the details described with reference to the systems and conceptual figures above may be combined with the descriptions of the process steps below to get a more complete and comprehensive understanding of these processes and the disclosed technologies.

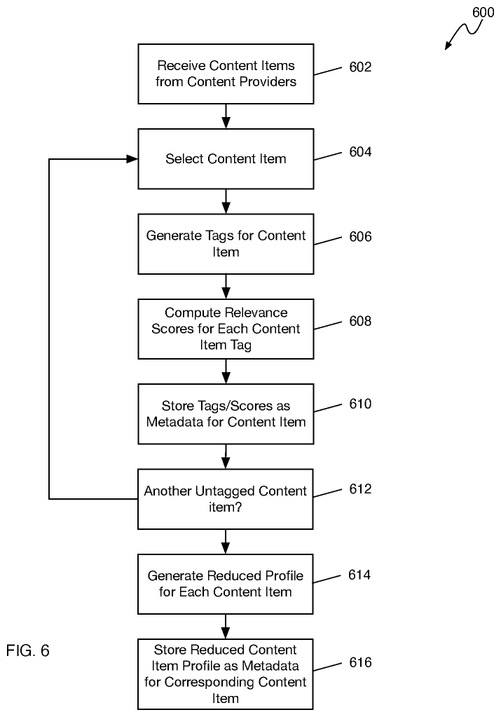

FIG. 6 is a flow diagram of an example process 600 for generating reduced content item profiles for content items. For example, a content item, or collection of content items, may be associated with thousands of tags that represent the subject matter of the content items. Processing so many tags to estimate the likelihood that a user will read the content item is inefficient. For example, a content item profile may have descriptive metadata that has hundreds or thousands of dimensions (e.g., attributes/values, tags/scores, etc.). Process 600 can perform a dimensionality reduction process (e.g., principle component analysis) to reduce the number of dimensions of a content item profile to a more manageable number (e.g., 8, 9, 10, etc.) of dimensions. Thus, ML module 128 may reduce the detailed content item profile (e.g., all tags/scores for a single content item) through principle component analysis into a reduced content item profile that includes values associated with the principle components (e.g., a combination of most important tags/topics) of the content item profiles. The principle components (e.g., eigenvectors representing a combination and/or ratio of topic tags) identified or selected during principle component analysis can define the attributes of the reduced content item profile. The values generated by projecting the tag scores onto the principle component vectors can correspond to the attribute values of the reduced content item profile.

At step 602, server device 120 can receive content items from content item publishers. For example, content service 122 can receive content items from content publisher 130, 132, and/or 134. The content publishers can correspond to various news agencies, movie studios, music studios, individual content producers, and the like. Content service 122 can store the received content items in content items database 126.

At step 604, server device 120 can select a content item for processing. For example, tagging module 124 can select an untagged content item (e.g., a newly received content item) for tagging with topic tags and/or tag relevance scores.

At step 606, server device 120 can generate tags for the selected content item. For example, tagging module 124 on server device 120 can generate or identify tags (e.g., topic tags) for received content items that represent the subject matter and/or focus of the content of the received content items. The tags can represent topics included in the content of a content item. The tags can represent a source or publisher for the content item. The tags can represent any other attribute of the content item, as may be described herein.

At step 606, server device 120 can compute relevance scores for each content item tag. For example, the tag score can represent how important or relevant the tag (e.g., topic, publisher, etc.) is to the content item. A content item that focuses on politics, mentions science, and is silent with respect to cooking will have a high score for the politics tag, a lower score for the science tag, and no cooking tag, for example. The tags and corresponding scores for a content item can be stored as metadata for the content item and stored with the content item in content item database 126, for example.

In some implementations, instead of associating only relevant tags with a content item in the content item metadata, a content item can be associated with all tags and the relevance scores for each tag can indicate the relevance or importance of each tag with respect to the corresponding content item. Thus, continuing the example above where a content item focuses on politics, mentions science, and is silent with respect to cooking, this content item may have all tags (e.g., thousands of tags identified from across all content items) included in the content item metadata, but will have non-zero scores only for relevant topic tags. For example, the metadata can include a high score for the politics tag, a lower score for the science tag, and a score of zero for the cooking tag and all other irrelevant topic tags.

At step 610, server device 120 can store the topic tags and corresponding relevance scores in the metadata for the selected content item. For example, tagging module 124 can store the topic tags and corresponding relevance scores in the metadata for the selected content item.

At step 612, server device 120 can determine if content database 126 includes another untagged content item. For example, when tagging module 124 determines that another untagged content item exists in content database 126, tagging module 124 can select the untagged content item at step 604. When no untagged content items exist in content database 126, tagging module can proceed to step 614.

At step 614, server device 120 can generate a reduced profile for each content item. For example, ML module 128 can perform principle component analysis across all, or a portion (e.g., the most recently received content items), of the content items in content items database 126 based on the attributes (e.g., topic tags) and corresponding attribute values (e.g., tag relevance scores) of each content item to determine the principle components of the collection of content items. For example, each principle component (e.g., defined by an eigenvector) can represent a combination of tags/attributes that account for the most variance in the topics associated with the content items. ML module 128 can select a number (e.g., 8, 9, 10, etc.) of the principle components that account for the most variance as the attributes for the reduced content item profile. The reduced content item attribute values for a specific content item can be calculated by projecting the tag relevance scores onto the eigenvectors for the selected principle components. Thus, through principle component analysis, ML module 128 can reduce the number of dimensions (e.g., attributes) in a content item profile from hundreds or thousands to a more manageable number (e.g., 8, 9, 10, etc.)

At step 616, server device 120 can store the reduced content item profile as metadata for the corresponding content item. For example, ML module 128 can store the reduced content item profile (e.g., selected principle components and corresponding projected values) as metadata for the corresponding content item. For example, the reduced content item profile can be stored as a vector of the values generated by projecting the content item tag scores onto the eigenvector for each principle component.

In some implementations, ML module 128 may store the definitions for the eigenvectors of the selected principle components so that reduced content item profiles for content items received subsequent to the principle component analysis may be generated. For example, reduced content item profiles for newly received content items may be generated by projecting the tag scores for newly received content items onto the previously determined and stored eigenvectors of the principle components.

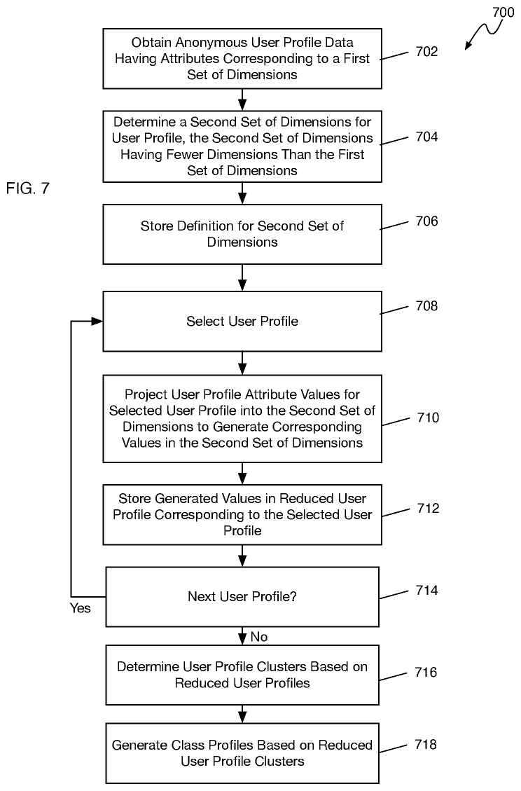

FIG. 7 is a flow diagram of an example process 700 for determining reduced user profile attributes and generating user class profiles. For example, process 700 can be performed by server device 120 to determine principle components of detailed user profiles and user class profiles based on anonymous user activity received from a large number of user devices.

At step 702, server device 120 can obtain anonymous user profile data. For example, the anonymous user profile data (e.g., detailed user profile) can be received from a large number of client devices (e.g., user device 110) and represent the content consumption behavior of a large number of users. The anonymous user profile data can be received as anonymous user activity data from client devices and can include a detailed user profile having hundreds or thousands of dimensions (e.g., detailed user profile attributes, topic tags, tag relevance scores, etc.) describing the content item preferences associated with a user of the particular client device. The anonymous user activity data, including the anonymous user profile data, can be received by and/or stored on server device 120 without information identifying a corresponding user or user device. Thus, while the anonymous user activity data may include detailed information about a particular user's content consumption habits, the anonymous user activity data cannot be traced back to a specific user or user device.

At step 704, server device 120 can determine a reduced set of dimensions for generating reduced user profiles. For example, server device 120 can process the anonymous user profiles using a dimensionality reduction method (e.g., Principle Component Analysis) to determine a reduced set of dimensions (e.g., principle components) that retain the variation present in the many different user profiles received by server device 120. The dimensionality reduction method can be used to generate a reduced user profile definition that has a number (e.g., 8, 9, 10, etc.) of dimensions or attributes that is much smaller than the hundreds or thousands of dimensions or attributes included in the detailed user profile.

At step 706, server device 120 can store the definitions for the reduced set of dimensions. For example, when using Principle Component Analysis to identify and select principle components, server device 120 can store the definitions for the principle components (e.g., eigenvectors) as definition for the attributes of the reduced user profile. For example, if nine (9) principle components are selected to represent a user profile, these nine principle components can correspond to the attributes of the reduced user profile. Server device 120 can store the definitions for the selected principle components as the definition of the detailed user profile so that server device 120 (or user device 110) can project attribute values (e.g., tag relevance scores, read probabilities, etc.) from the detailed user profile onto the principle components to generate attribute values for a reduced user profile corresponding to a specific user, as described further below.

At step 708, server device 120 can select an anonymous detailed user profile. For example, server device 120 can select an anonymous detailed user profile from the large number of anonymous detailed user profiles for which a reduced user profile (e.g. having calculated attribute values) has not yet been generated.

At step 710, server device 120 can project the detailed user profile attribute values for the selected user profile into the reduced set of dimensions to generate corresponding values in the reduced set of dimensions. For example, when Principle Component Analysis was used to generate the reduced set of dimensions (e.g., reduced user profile attributes), server device 120 can project the attribute values from the detailed user profile onto the eigenvectors corresponding to each of the principle components of the reduced user profile to generate corresponding attribute values for the attributes of the reduced user profile.

At step 712, server device 120 can store the generated values in the reduced user profile corresponding to the selected detailed user profile. For example, server device 120 can store the values generated as a result of projecting the detailed user profile attribute values onto the eigenvectors for each principle component as values for corresponding attributes of a reduced user profile corresponding to the selected detailed user profile.

At step 714, server device 120 can determine whether there is another anonymous detailed user profile that does not have a corresponding reduced user profile. For example, if there remain some anonymous detailed user profiles that do not have a corresponding reduced user profile, process 700 can return to step 708 and select another detailed user profile to process. If reduced user profiles have been generated for all anonymous detailed user profiles, then process 700 can continue to step 716.

At step 716, server device 120 can determine user profile clusters based on the generated reduced user profiles. For example, server device 120 can cluster all of the generated reduced user profiles into groups of reduced user profiles that have similar attribute values. For example, reduced user profiles that are in the same cluster represent users who have the same or similar interests and are likely to view content items that have the same or similar subject matter.

At step 718, server device 120 can generate class profiles based on the reduced user profile clusters. For example, server device 120 can generate class profiles that conform to a k-anonymity method of privacy protection. For example, if server device is configured to provide k-anonymity with k=5000 users, then server device 120 can generate reduced user profile clusters that include at least 5000 distinct reduced user profiles. Server device 120 can then generate a class profile representing each cluster. For example, server device 120 can generate a particular class profile for a particular cluster by determining reduced user profile attribute values corresponding to the centroid of each cluster and storing those centroid attribute values as the particular class profile for the particular cluster. Thus, the generated class profiles can be used to provide k-anonymity to the user of user device 110 when providing traceable (e.g., mapped to a user account, email address, etc.) user profile data to server device 120, as described above.

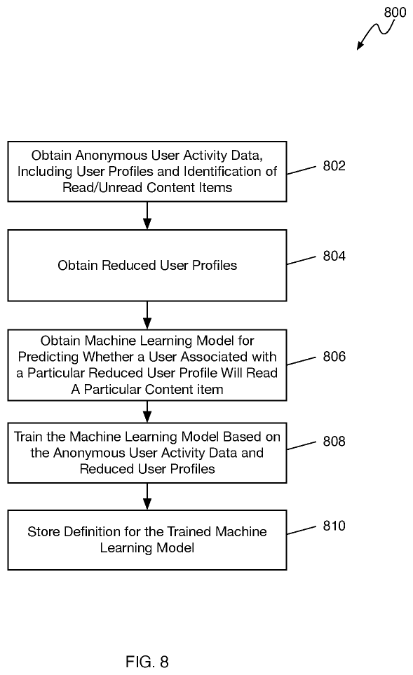

FIG. 8 is a flow diagram of an example process 800 for training a machine learning model to generate content item scores based on past user behavior. For example, process 800 can be performed by server device 120 to generate a machine learning model configuration for distribution to client devices (e.g., user device 110).

At step 802, server device 120 can obtain anonymous user activity data. For example, server device 120 can receive anonymous user activity data from a large number of user devices (e.g., user device 110). The anonymous user activity data received from a particular user device can include an anonymous detailed user profile associated with the user of the particular user device and identifiers for content items that were read and/or passed over (e.g., presented to the user and not read) by the user. Thus, the anonymous user activity data can be used to correlate user interests and content consumption behavior (e.g., as indicated by the user profile) to the subject matter or topics associated with content items read or not read by a user having a specific user profile. The machine learning model can be trained to generate content item scores representing the likelihood that a user will read a content item based on a user profile associated with the user and a content item profile associated with a candidate content item, as described herein.

At step 804, server device 120 can obtain reduced user profiles corresponding to the anonymous user activity data. For example, server device 120 can generate a reduced user profile for each detailed user profile received in the anonymous user activity data received from the various user devices. For example, server device 120 can generate reduced user profiles as described with reference to FIG. 7.

At step 806, server device 120 can obtain a machine learning model for predicting whether a user associated with a particular reduced user profile will read a particular content item. For example, the machine learning model can be implemented as a neural network and initially configured with default values for input weights, biases, and other configurable, trainable aspects of the neural network. The neural network can be configured to receive a reduced user profile corresponding to a particular user (e.g., an anonymous user during training) and a reduced content item profile corresponding to a particular content item as input and output a content item score representing the likelihood that the particular user will read the particular content item.

At stop 808, server device 120 can train the machine learning model based on the anonymous user activity data and the reduced user profiles. For example, the machine learning model can be implemented as a neural network. The neural network can be trained using a supervised training approach that provides inputs and corresponding desired outputs to the neural network. The inputs can be an anonymous reduced user profile and the content item profile of the content item viewed, or not viewed, by the user corresponding to the reduced user profile. The desired output can be a content item score indicating that the user will view (e.g., if training is done with a viewed content item) or not view (e.g., if training is done with an unviewed content item) the content item. The network then processes the inputs and compares its resulting outputs against the desired outputs. Errors are then propagated back through the system, causing the system to adjust the weights which control the neural network. This process may occur over and over across many different anonymous reduced user profiles as the weights of the neural network are continually tweaked until the neural network produces reliable content item scores. During the training of a network the same set of data (e.g., inputs and desired outputs) may be processed many times as the connection weights are ever refined.

At step 810, server device 120 can store the definition for the trained machine learning model. For example, after training the neural network, server device 120 can store the node functions, node relationships, weights, biases, and/or other data associated with the trained neural network. Server device 120 can then use the stored neural network definition to generate content item scores for candidate content items and perform personalized selection of content items on server device 120. Server device 120 can distribute the stored neural network definition to client devices (e.g., user device 110) in configuration 202 so that the client devices can use the neural network to generate content item scores for candidate content items and perform personalized selection of content items on the client devices.

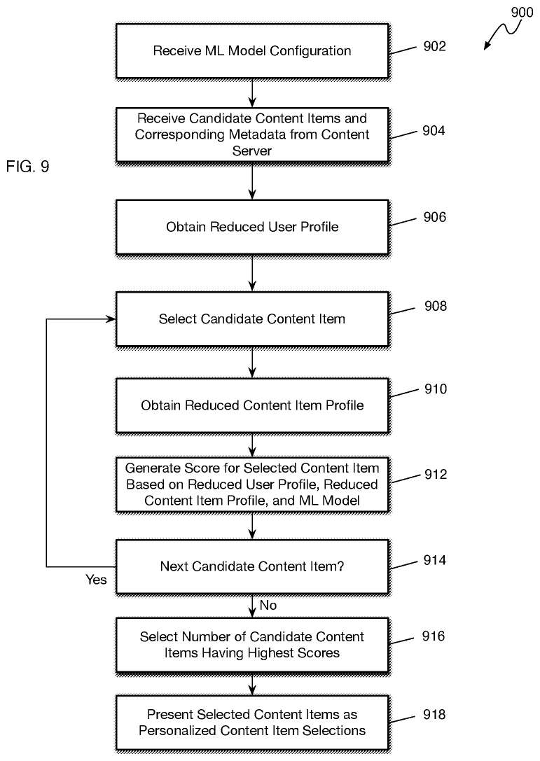

FIG. 9 is a flow diagram of an example process 900 for performing personalized selection of content items on a client device. For example, process 900 can be performed by user device 110 to generate a personalized selection of content items from a collection of candidate content items received from a server device based on ML model 300 described above.

At step 902, user device 110 can receive ML model configuration data. For example, content application 112 can receive configuration 202 described above with reference to FIG. 2. Configuration 202 can include a definition for a current version of a machine learning model (e.g., neural network) configured to generate content item scores (e.g., a number between 0 and 1, between −1 and 1, between 0 and 100, etc.) representing the likelihood that a user corresponding to a particular user profile will read or consume a content item corresponding to a particular content item profile. Configuration 202 can include a reduced user profile definition that includes definitions for each attribute (e.g., principle components, eigenvectors, etc.) of the reduced user profile so that user device 110 can generate a reduced user profile for the user of user device 110 based on the received reduced user profile definition.

In some implementations, user device 110 can receive configuration 202 when there has been an update to the ML model and/or reduced user profile definition. For example, content application 112 can receive configuration 202 defining a first version of the ML model definition and/or a first version of the reduced user profile definition. Content application 112 can use these versions of the ML model definition and reduced user profile definition to process candidate content items received from server device 120 over a duration of time until server device generates an updated ML model definition and/or reduced user profile definition. When server device 120 generates an updated ML model definition and/or reduced user profile definition, server device 120 can send configuration 202 that includes data defining a second version of the ML model definition and/or a second version of the reduced user profile definition. Step 902 can be performed every time candidate content items are received by user device 110 or when server device 120 makes updates to the ML model definition, reduced content item profile definition, and/or reduced user profile definition.

At step 904, user device 110 can receive candidate content items and corresponding metadata from server device 120. For example, content application 112 can receive candidate content items that were automatically and/or manually selected at server device 120. The metadata for each content item can include a detailed content item profile. The metadata for each content item can include a reduced content item profile generated by server device 120 based on the detailed content item profile.

In some implementations, content application 112 can receive candidate content items on a periodic basis (e.g., every 12 hours, every 24 hours, etc.). Content application 112 can receive candidate content items in response to a user invoking content application 112. For example, in response to receiving input invoking content application 112, content application 112 can request content items from server device 120. In response to the request, server device 120 can send candidate content items to content application 112.

At step 906, user device 110 can obtain a reduced user profile corresponding to a user of user device 110. For example, content application 112 can obtain a detailed user profile generated and stored on user device 110. Content application 112 (or ML module 114) can use the reduced user profile definition received at step 902 to generate a reduced user profile based on the detailed user profile, as described above. If a reduced user profile has already been generated, content application 112 can obtain the previously generated reduced user profile from storage (e.g., memory, hard drive, network storage, etc.). Content application 112 may periodically (e.g., every day, every 8 hours, etc.) or in response to some event, generate a new reduced user profile. For example, if an attribute of the detailed user profile has changed significantly (e.g., by some threshold amount, percentage, etc.) then content application 112 can generate a new reduced user profile based on the detailed user profile.

At step 908, user device 110 can select a candidate content item. For example, content application 112 can select a candidate content item from among the collection of candidate content items received at step 904. Content application 112 can select a candidate content item for which a content item score has not yet been generated, for example.

At step 910, user device 110 can obtain a reduced content item profile for the selected candidate content item. For example, content application 112 can obtain the reduced content item profile from the metadata corresponding to the selected candidate content item received at step 904. In some implementations, content application 112 (or ML module 114) can generate the reduced content item profile from the detailed content item profile for the selected candidate content item received at step 904. For example, content application 112 (or ML module 114) can generate the reduced content item profile based on the reduced content item profile definition received at step 902 and the detailed content item profile for the selected candidate content item received at step 904, as described above.

At step 912, user device 110 can generate a score for the selected content item based on the reduced user profile, the reduced content item profile and the ML model. For example, content application 112 can provide the reduced user profile and the reduced content item profile as input to ML module 114 (e.g., the ML model) and ML module 114 can generate a content item score for the selected candidate content item as output, as described above with reference to ML model 300 of FIG. 3.

At step 914, user device 110 can determine if another unscored candidate content item exists in the collection of received candidate content items. For example, when content application 112 determines that another unscored candidate content item exists in the collection of received candidate content items, process 900 can return to step 908 where an unscored candidate content item can be selected. When another unscored candidate content item does not exist in the collection of received candidate content items, process 900 can continue to step 916.

At step 916, user device 110 can select a number of candidate content items having the highest scores. For example, content application 112 can rank, or sort, the candidate content items by content item score and select a number of the highest scored content items. For example, the number of candidate content items selected can be based on the number of content items needed to populate a user interface of content application 112.

At step 918, user device 110 can present the selected content items. For example, content application 112 can present the selected content items on a display of user device 110.

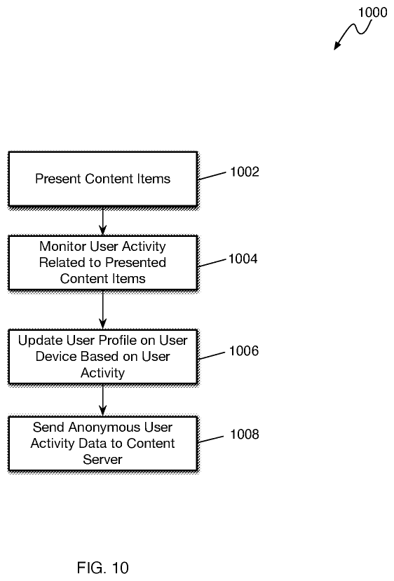

FIG. 10 is a flow diagram of an example process 1000 for updating a detailed user profile based on user content viewing activity. For example, process 1000 can be performed by user device 110 to update a user's detailed user profile and send anonymous user activity data to server device 120.

At step 1002, user device 110 can present content items. For example, content application 112 can present the personalized content item selections generated using process 900 on a display of user device 110. The user of user device 110 can interact with content application 112 to browse the presented content items and select content items to consume or view.

At step 1004, user device 110 can monitor user activity related to the presented content items. For example, content application 112 can record data identifying which content items were presented, which content items were read or viewed, and which content items the user passed over (e.g., did not view).

At step 1006, user device 110 can update a detailed user profile corresponding to the user based on the user's content viewing activity. For example, content application 112 can obtain the detailed content item profiles for the presented content items from the metadata corresponding to the presented content items.

For content items the user has viewed (e.g., read, watched, consumed, etc.), content application 112 can update the read content profile portion of the detailed user profile. For example, content application 112 can calculate an average relevance score for each of the topic tags associated with each read content item. These average relevance scores can be stored in the read content profile portion (e.g., read content profile 314) of the user's detailed profile.

For content items the user has not viewed (e.g., passed over, ignored, not read, etc.), content application 112 can update the unread content profile portion of the detailed user profile. For example, content application 112 can calculate an average relevance score for each of the topic tags associated with each unread content item. These average relevance scores can be stored in the unread content profile portion (e.g., unread content profile 316) of the user's detailed profile.

In some implementations, content application 112 can update groupable topics read probabilities 318. For example, for each groupable topic (e.g., sports, politics, science, etc.), content application 112 can generate a score representing a probability that the user will consume content items related to the corresponding groupable topic. For example, the score for a particular groupable topic can be calculated as a ratio of the number of content items associated with a particular groupable topic that were read divided by the total number of content items read. The score for a particular groupable topic can be calculated as a ratio of the number of content items associated with a particular groupable topic that were read divided by the total number of content items presented (e.g., read and unread content items). Of course, other scoring method may be used in addition to, or as an alternative to, the above scoring methods.

In some implementations, content application 112 can update publishers read probabilities 320. For example, for each publisher (e.g., website, newspaper, news outlet, content source, etc.), content application 112 can generate a score representing a probability that the user will consume content items from the corresponding publisher. For example, the score for a particular publisher can be calculated as a ratio of the number of content items associated with a particular publisher that were read divided by the total number of content items read. The score for a particular publisher can be calculated as a ratio of the number of content items associated with a particular publisher that were read divided by the total number of content items presented (e.g., read and unread content items). Of course, other scoring method may be used in addition to, or as an alternative to, the above scoring methods.

At step 1008, user device 110 can send anonymous user activity data to server device 110. For example, content application 112 can send anonymous user activity data that includes the (e.g., updated) detailed user profile and data identifying the read content items and/or the unread content items. Content application 112 can send the anonymous user activity data without any data that identifies user device 110 and/or the user of user device 110. Content application 112 can send the anonymous user activity data periodically (e.g., every 8 hours, every 24 hours, every 2 days, every week, etc.). Content application 112 can send the anonymous user activity data in response to an event, such as the invocation of content application 112, user device 110 entering an idle state, and/or any other triggering event.

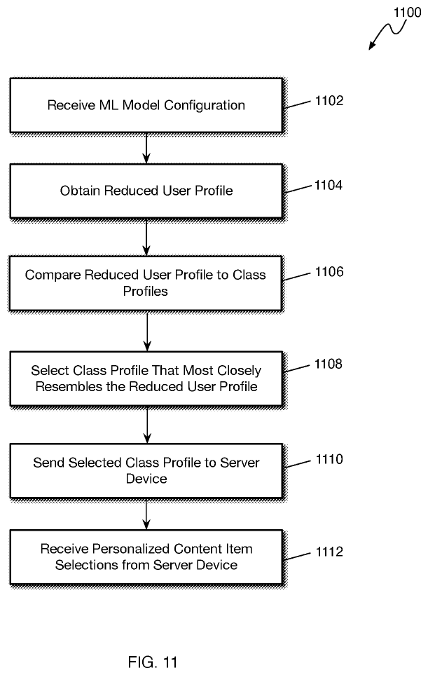

FIG. 11 is a flow diagram of an example process 1100 for providing anonymized personalization information for server-side personalized content selection. For example, process 1100 can be performed by server device 120 to select content items for presentation to a user based on a class profile (e.g., an anonymized user profile). For example, process 1100 can correspond to user profile leg 510 of ML model 500.

At step 1102, user device 110 can receive ML model configuration data. For example, content application 112 can receive configuration 202 described above with reference to FIG. 2. Configuration 202 can include a reduced user profile definition that includes definitions for each attribute (e.g., principle components, eigenvectors, etc.) of the reduced user profile so that user device 110 can generate a reduced user profile for the user of user device 110 based on the received reduced user profile definition. Configuration 202 can include various user class profiles that represent various groups of similar user profiles (e.g., reduced user profiles), as described above.

In some implementations, user device 110 can receive configuration 202 when there has been an update to the reduced user profile definition, and/or updates to the user class profiles. For example, content application 112 can receive configuration 202 defining a first collection of user class profiles, and/or a first version of the reduced user profile definition. Content application 112 can use these versions of the class profiles and reduced user profile definition to generate a reduced user profile and select a class profile that serves as an anonymous (e.g., k-anonymity) approximation of the user profile, as described above and below. When server device 120 generates updated class profiles and/or reduced user profile definition, server device 120 can send configuration 202 that includes data defining a second collection of user class profiles and/or a second version of the reduced user profile definition. Step 902 can be performed every time candidate content items are received by user device 110 or when server device 120 makes updates to the ML model definition, reduced content item profile definition, and/or reduced user profile definition.

At step 1104, user device 110 can obtain a reduced user profile corresponding to a user of user device 110. For example, content application 112 can obtain a detailed user profile generated by and/or stored on user device 110. Content application 112 (or ML module 114) can use the reduced user profile definition received at step 902 to generate a reduced user profile based on the user's detailed user profile, as described above. If a reduced user profile has already been generated, content application 112 can obtain the previously generated reduced user profile from storage (e.g., memory, hard drive, network storage, etc.). Content application 112 may periodically (e.g., every day, every 8 hours, etc.) or in response to some event, generate a new reduced user profile. For example, if an attribute of the detailed user profile has changed significantly (e.g., by some threshold amount, percentage, etc.) then content application 112 can generate a new reduced user profile based on the changed detailed user profile.

At step 1108, user device 110 can compare the reduced user profile to the class profiles. For example, content application 122 can compare the reduced user profile to each of the various class profiles to identify a class profile that most closely resembles (e.g., approximates, is most similar to) the reduced user profile for the user of user device 110.

At step 1110, user device 110 can select a class profile that most closely resembles the reduced user profile. For example, content application 112 can select a particular class profile that best approximates the reduced user profile.

At step 1112, user device 110 can send the selected class profile to server 120. For example, the selected class profile can be sent with an identifier (e.g., email address, account identifier, device identifier, etc.) associated with user device 110 and/or a user of user device 110. However, by sending the class profile (e.g. representing 5000, 6000, 10,000 users) instead of the reduced user profile (e.g., representing one user), content application 112 can introduce a level of anonymity (e.g., k-anonymity) to the user profile (e.g., class profile) sent to server device 120 that may provide an additional level of privacy for the user even though the class profile is associated with a specific user or device identifier.

At step 1112, user device 110 can receive personalized content item selections from server device 120. For example, server device 120 can use the class profile to perform personalized selection of content items and send the personalized selection of content items to the user, or user device, using the identifier associated with the class profile. For example, when the user identifier is an email address, server device 120 can send an email to the email address (e.g., through messaging application 116) that includes the selected content items that conform to the user's content preferences as approximated by the class profile sent by content application 112.

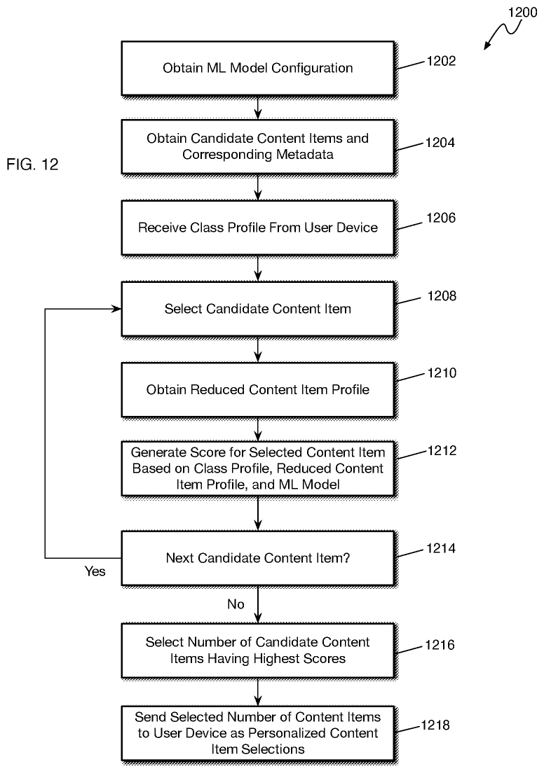

FIG. 12 is a flow diagram of an example process 1200 for privacy preserving personalized selection of content items at a server device. For example, process 1200 can be performed by server device 120 based on a class profile that approximates a user profile of a specific user. For example, process 1200 can correspond to content profile leg 840 and content scoring layer 550 of ML model 500. Process 1200 can be performed on server device 120 so that content service 122 can generate and send messages (e.g., email newsletters) to user devices that include content item suggestions personalized for a particular user's preferences in a privacy preserving manner.

At step 1202, server device 120 can obtain ML model configuration data. For example, content service 122 can obtain a definition for a current version of a machine learning model (e.g., neural network) configured to generate content item scores (e.g., a number between 0 and 1, between −1 and 1, between 0 and 100, etc.) representing the likelihood that a user corresponding to a particular user profile will read or consume a content item corresponding to a particular content item profile. The ML model can be updated (e.g., retrained) over time (e.g., periodically, in response to some event, etc.) so that over time the ML model can become a better predictor of user content consumption behavior.

At step 1204, server device 120 can obtain candidate content items and corresponding metadata. For example, content service 122 can receive candidate content items that were automatically selected by content service 122 and/or manually selected (e.g., curated) by an administrator of content service 122. The metadata for each content item can include a detailed content item profile having hundreds or thousands of topic tags and corresponding relevance scores. The metadata for each content item can include a reduced content item profile generated by server device 120 based on the detailed content item profile for the corresponding content item. In some implementations, content service 122 can obtain candidate content items on a periodic basis (e.g., every 12 hours, every 24 hours, etc.).

At step 1206, server device 120 can receive a class profile corresponding to a user of user device 110. For example, content service 122 can obtain a class profile selected by user device 110 based on a reduced user profile generated for the user of user device 110. Content service 122 may periodically (e.g., every day, every 8 hours, etc.) or in response to some event, request and/or receive from content application 112 a class profile associated with the user of user device 110. For example, content application 112 may automatically send the class profile to content service 122 periodically. Content application 112 may send the class profile to content service 122 in response to a request from content service 122. The class profile may be received with a user identifier (e.g., account identifier, email address, device identifier, etc.) that can be used to send personalized content item suggestions to the user of user device 110.

At step 1208, server device 120 can select a candidate content item. For example, content service 122 can select a candidate content item from among the collection of candidate content items obtained at step 1204. Content service 122 can select a candidate content item for which a content item score has not yet been generated, for example.

At step 1210, server device 120 can obtain a reduced content item profile for the selected candidate content item. For example, content service 122 can obtain the reduced content item profile from the metadata corresponding to the selected candidate content item. In some implementations, content service 122 (or ML module 128) can generate the reduced content item profile from the detailed content item profile for the selected candidate content item. For example, content service 122 (or ML module 128) can generate the reduced content item profile based on the reduced content item profile definition and the detailed content item profile for the selected candidate content item, as described above.

At step 1212, server device 120 can generate a score for the selected content item based on the reduced user profile, the reduced content item profile and the ML model. For example, content service 122 can provide the reduced user profile and the reduced content item profile as input to ML module 128 (e.g., ML model 500) and ML module 128 can generate a content item score for the selected candidate content item as output, as described above with reference to ML model 500 of FIG. 5.

At step 1214, server device 120 can determine if another unscored candidate content item exists in the collection of obtained candidate content items. For example, when content service 122 determines that another unscored candidate content item exists in the collection of received candidate content items, process 1200 can return to step 1208 where an unscored candidate content item can be selected. When another unscored candidate content item does not exist in the collection of received candidate content items, process 1200 can continue to step 1216.

At step 1216, server device 120 can select a number of candidate content items having the highest scores. For example, content service 122 can rank, or sort, the candidate content items by content item score and select a number (e.g., 6, 10, 15, etc.) of the highest scored content items. For example, the number of candidate content items selected can be based on the number of content items configured to be presented in the suggested content items message (e.g., email, newsletter, etc.).

At step 1218, server device 120 can send the selected number of content items to user device 110 as personalized content item selections. For example, content service 122 can send the selected content items in an email newsletter to the user email address received with the user class profile. Messaging application 116 (e.g., an email application) on user device 110 can receive the email newsletter and present the email newsletter, including the personalized content item selections, to the user of user device 110. Thus, content service 122 can cause the personalized content item selections to be presented to the user on user device 110 even if the user has not interacted with content application 112 for some period of time.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

As described above, one aspect of the present technology is the gathering and use of data available from various sources to improve the personalized selection of content items for presentation to the user and increase user engagement with the content service and/or content application. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to more quickly find content in which they are interested. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of personalized content selection and delivery, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

### Example System Architecture

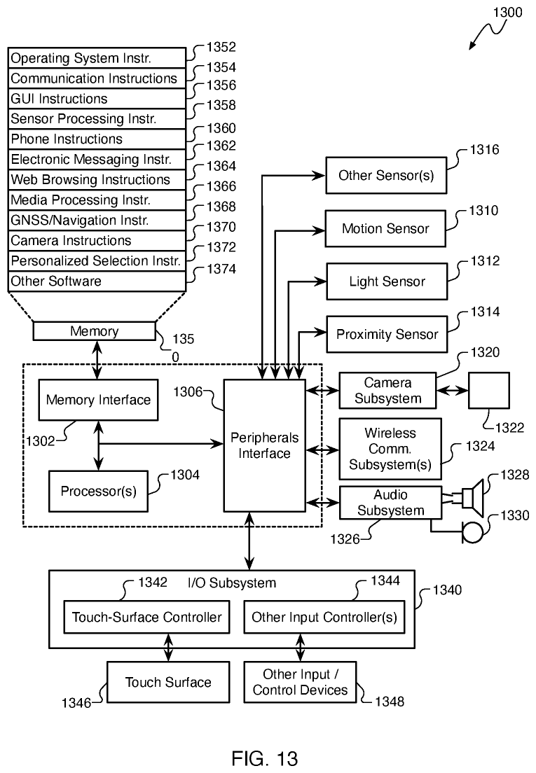

FIG. 13 is a block diagram of an example computing device 1300 that can implement the features and processes of FIGS. 1-12. The computing device 1300 can include a memory interface 1302, one or more data processors, image processors and/or central processing units 1304, and a peripherals interface 1306. The memory interface 1302, the one or more processors 1304 and/or the peripherals interface 1306 can be separate components or can be integrated in one or more integrated circuits. The various components in the computing device 1300 can be coupled by one or more communication buses or signal lines.

Sensors, devices, and subsystems can be coupled to the peripherals interface 1306 to facilitate multiple functionalities. For example, a motion sensor 1310, a light sensor 1312, and a proximity sensor 1314 can be coupled to the peripherals interface 1306 to facilitate orientation, lighting, and proximity functions. Other sensors 1316 can also be connected to the peripherals interface 1306, such as a global navigation satellite system (GNSS) (e.g., GPS receiver), a temperature sensor, a biometric sensor, magnetometer or other sensing device, to facilitate related functionalities.

A camera subsystem 1320 and an optical sensor 1322, e.g., a charged coupled device (CCD) or a complementary metal-oxide semiconductor (CMOS) optical sensor, can be utilized to facilitate camera functions, such as recording photographs and video clips. The camera subsystem 1320 and the optical sensor 1322 can be used to collect images of a user to be used during authentication of a user, e.g., by performing facial recognition analysis.

Communication functions can be facilitated through one or more wireless communication subsystems 1324, which can include radio frequency receivers and transmitters and/or optical (e.g., infrared) receivers and transmitters. The specific design and implementation of the communication subsystem 1324 can depend on the communication network(s) over which the computing device 1300 is intended to operate. For example, the computing device 1300 can include communication subsystems 1324 designed to operate over a GSM network, a GPRS network, an EDGE network, a Wi-Fi or WiMax network, and a Bluetooth™ network. In particular, the wireless communication subsystems 1324 can include hosting protocols such that the device 100 can be configured as a base station for other wireless devices.

An audio subsystem 1326 can be coupled to a speaker 1328 and a microphone 1330 to facilitate voice-enabled functions, such as speaker recognition, voice replication, digital recording, and telephony functions. The audio subsystem 1326 can be configured to facilitate processing voice commands, voiceprinting and voice authentication, for example.

The I/O subsystem 1340 can include a touch-surface controller 1342 and/or other input controller(s) 1344. The touch-surface controller 1342 can be coupled to a touch surface 1346. The touch surface 1346 and touch-surface controller 1342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1346.

The other input controller(s) 1344 can be coupled to other input/control devices 1348, such as one or more buttons, rocker switches, thumb-wheel, infrared port, USB port, and/or a pointer device such as a stylus. The one or more buttons (not shown) can include an up/down button for volume control of the speaker 1328 and/or the microphone 1330.

In one implementation, a pressing of the button for a first duration can disengage a lock of the touch surface 1346; and a pressing of the button for a second duration that is longer than the first duration can turn power to the computing device 1300 on or off. Pressing the button for a third duration can activate a voice control, or voice command, module that enables the user to speak commands into the microphone 1330 to cause the device to execute the spoken command. The user can customize a functionality of one or more of the buttons. The touch surface 1346 can, for example, also be used to implement virtual or soft buttons and/or a keyboard.

In some implementations, the computing device 1300 can present recorded audio and/or video files, such as MP3, AAC, and MPEG files. In some implementations, the computing device 1300 can include the functionality of an MP3 player, such as an iPod™.

The memory interface 1302 can be coupled to memory 1350. The memory 1350 can include high-speed random-access memory and/or non-volatile memory, such as one or more magnetic disk storage devices, one or more optical storage devices, and/or flash memory (e.g., NAND, NOR). The memory 1350 can store an operating system 1352, such as Darwin, RTXC, LINUX, UNIX, OS X, WINDOWS, or an embedded operating system such as VxWorks.

The operating system 1352 can include instructions for handling basic system services and for performing hardware dependent tasks. In some implementations, the operating system 1352 can be a kernel (e.g., UNIX kernel). In some implementations, the operating system 1352 can include instructions for performing personalized selection of content. For example, operating system 1352 can implement the personalized content selection features as described with reference to FIGS. 1-12.

The memory 1350 can also store communication instructions 1354 to facilitate communicating with one or more additional devices, one or more computers and/or one or more servers. The memory 1350 can include graphical user interface instructions 1356 to facilitate graphic user interface processing; sensor processing instructions 1358 to facilitate sensor-related processing and functions; phone instructions 1360 to facilitate phone-related processes and functions; electronic messaging instructions 1362 to facilitate electronic-messaging related processes and functions; web browsing instructions 1364 to facilitate web browsing-related processes and functions; media processing instructions 1366 to facilitate media processing-related processes and functions; GNSS/Navigation instructions 1368 to facilitate GNSS and navigation-related processes and instructions; and/or camera instructions 1370 to facilitate camera-related processes and functions.

The memory 1350 can store software instructions 1372 to facilitate other processes and functions, such as the personalize content selection processes and functions as described with reference to FIGS. 1-12.

The memory 1350 can also store other software instructions 1374, such as web video instructions to facilitate web video-related processes and functions; and/or web shopping instructions to facilitate web shopping-related processes and functions. In some implementations, the media processing instructions 1366 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1350 can include additional instructions or fewer instructions. Furthermore, various functions of the computing device 1300 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A method comprising:
obtaining, by a server device, a plurality of candidate content items, where each candidate content item in the plurality of candidate content items is associated with a content item profile;
receiving, by the server device, a particular class profile from a user device, the particular class profile approximating a number of similar user profiles representing many different users including a particular user profile of a particular user of the user device;
generating, by the server device, a content item score for each of the plurality of candidate content items based on the particular class profile and the content item profiles associated with the candidate content items;
selecting, by the server device, a plurality of selected content items based on the content item scores generated for each candidate content item; and
causing, by the server device, the plurality of selected content items to be presented on a display of the user device.

2. The method of claim 1, further comprising:
generating, by the server device, a plurality of class profiles, including the particular class profile, based on a plurality of anonymous user profiles received from a plurality of user devices; and
sending, by the server device, the plurality of class profiles, including the particular class profile, to the user device, wherein the particular class profile is selected based on a user profile describing content viewing preferences of the user of the user device.

3. The method of claim 1, wherein the plurality of class profiles are generated based on reduced user profiles generated by combining multiple attributes of the detailed user profile into a single attribute of the reduced user profile using a dimensionality reduction process.

4. The method of claim 1, wherein the user profile includes a read content profile that describes attributes of content read by the user and an unread content profile that describes attributes of content that was presented to the user but unread by the user.

5. The method of claim 4, wherein the user profile includes probabilities for groupable topics indicating whether the user is likely to read content associated with a corresponding groupable topic.

6. The method of claim 1, wherein the particular class profile was selected from the plurality of class profiles based on a particular detailed user profile generated by the user device.

7. The method of claim 1, further comprising:
generating, by the server device, a first user class profile of the plurality of class profiles that represents a first cluster of anonymous user profiles that have similar attributes values with respect to other anonymous user profiles within the first cluster; and
generating, by the server device, a second user class profile of the plurality of class profiles that represents a second cluster of anonymous user profiles that have similar attributes values with respect to other anonymous user profiles within the second cluster,
wherein the first user class profile is distinct from the second user class profile.

8. A non-transitory computer readable medium including one or more sequences of instructions that, when executed by one or more processors, cause the processors to perform operations comprising:
obtaining, by a server device, a plurality of candidate content items, where each candidate content item in the plurality of candidate content items is associated with a content item profile;
receiving, by the server device, a particular class profile from a user device, the particular class profile approximating a number of similar user profiles representing many different users including a particular user profile of a particular user of the user device;
generating, by the server device, a content item score for each of the plurality of candidate content items based on the particular class profile and the content item profiles associated with the candidate content items;
selecting, by the server device, a plurality of selected content items based on the content item scores generated for each candidate content item; and
causing, by the server device, the plurality of selected content items to be presented on a display of the user device.

9. The non-transitory computer readable medium of claim 8, wherein the instructions cause the processors to perform operations comprising:
generating, by the server device, a plurality of class profiles, including the particular class profile, based on a plurality of anonymous user profiles received from a plurality of user devices; and
sending, by the server device, the plurality of class profiles, including the particular class profile, to the user device, wherein the particular class profile is selected based on a user profile describing content viewing preferences of the user of the user device.

10. The non-transitory computer readable medium of claim 8, wherein the plurality of class profiles are generated based on reduced user profiles generated by combining multiple attributes of the detailed user profile into a single attribute of the reduced user profile using a dimensionality reduction process.

11. The non-transitory computer readable medium of claim 8, wherein the user profile includes a read content profile that describes attributes of content read by the user and an unread content profile that describes attributes of content that was presented to the user but unread by the user.

12. The non-transitory computer readable medium of claim 11, wherein the user profile includes probabilities for groupable topics indicating whether the user is likely to read content associated with a corresponding groupable topic.

13. The non-transitory computer readable medium of claim 8, wherein the particular class profile was selected from the plurality of class profiles based on a particular detailed user profile generated by the user device.

14. The non-transitory computer readable medium of claim 8, wherein the instructions cause the processors to perform operations comprising:
generating, by the server device, a first user class profile of the plurality of class profiles that represents a first cluster of anonymous user profiles that have similar attributes values with respect to other anonymous user profiles within the first cluster; and
generating, by the server device, a second user class profile of the plurality of class profiles that represents a second cluster of anonymous user profiles that have similar attributes values with respect to other anonymous user profiles within the second cluster.

15. A system comprising:
one or more processors; and
a non-transitory computer readable medium including one or more sequences of instructions that, when executed by the one or more processors, cause the processors to perform operations comprising:
obtaining, by a server device, a plurality of candidate content items, where each candidate content item in the plurality of candidate content items is associated with a content item profile;
receiving, by the server device, a particular class profile from a user device, the particular class profile approximating a number of similar user profiles representing many different users including a particular user profile of a particular user of the user device;
generating, by the server device, a content item score for each of the plurality of candidate content items based on the particular class profile and the content item profiles associated with the candidate content items;
selecting, by the server device, a plurality of selected content items based on the content item scores generated for each candidate content item; and
causing, by the server device, the plurality of selected content items to be presented on a display of the user device.

16. The system of claim 15, wherein the instructions cause the processors to perform operations comprising:
generating, by the server device, a plurality of class profiles, including the particular class profile, based on a plurality of anonymous user profiles received from a plurality of user devices; and
sending, by the server device, the plurality of class profiles, including the particular class profile, to the user device, wherein the particular class profile is selected based on a user profile describing content viewing preferences of the user of the user device.

17. The system of claim 15, wherein the plurality of class profiles are generated based on reduced user profiles generated by combining multiple attributes of the detailed user profile into a single attribute of the reduced user profile using a dimensionality reduction process.

18. The system of claim 15, wherein the user profile includes a read content profile that describes attributes of content read by the user and an unread content profile that describes attributes of content that was presented to the user but unread by the user.

19. The system of claim 18, wherein the user profile includes probabilities for groupable topics indicating whether the user is likely to read content associated with a corresponding groupable topic.

20. The system of claim 15, wherein the particular class profile was selected from the plurality of class profiles based on a particular detailed user profile generated by the user device.

21. The system of claim 15, wherein the instructions cause the processors to perform operations comprising:
generating, by the server device, a first user class profile of the plurality of class profiles that represents a first cluster of anonymous user profiles that have similar attributes values with respect to other anonymous user profiles within the first cluster; and
generating, by the server device, a second user class profile of the plurality of class profiles that represents a second cluster of anonymous user profiles that have similar attributes values with respect to other anonymous user profiles within the second cluster.
